(19) United States
(12) Patent Application Publication
(10) Pub. No.: US 2006/0137996 A1
(43) Pub. Date: Jun. 29, 2006

(54) MPULSE 3000

(75) Inventor: Sven none Mierswa, San Carlos, Nuevo Guaymas (MX)

Correspondence Address: Mr. Sven (none) Mierswa, Blvd Gabriel Estrada local 5 Marina Terra, San Carlos, Nuevo Guaymas, 85506, MX

(73) Assignees: Sven none Mierswa, San Carlos,Nuevo Guaymas (MX); Matthew Clay Young, San Carlos, Nuevo Guaymas (MX); Elbert Harry Clark, Tucson, AZ (US)

(21) Appl. No.: 10/905,313

(22) Filed: Dec. 27, 2004

(51) Int. Cl. B23H 3/00

(52) U.S. Cl. 205/705; 205/706

(57) ABSTRACT

The MPULSE 3000 System (fig C) sends a controlled high frequency (between 3125 and 4250 Times per second), a positive and negative low voltage Impulse between the stainless steel anode and cathode (see Fig B) to create a consistently changing electric Field. The Frequency, Voltage and Amperage are microchip controlled by the conductivity of the water. The MPULSE 3000 System (Fig C) controls the amount of the impulses (between 3125 and 4250 Times per second) utilized in the water to ensure the change from Calcium Bi-Carbonate to Calcium Carbonate and into the non-adherent Crystals (Aragonite). The formed Impulse (110 microsecond positive/32 microsecond break/110 microsecond negative/32 microsecond break), Voltage (16v) and Amperage (70 mA) are precisely calculated to insure that the stainless steel Anode and Cathode (see Fig B) in the water are complete stabilized and will not corrode.

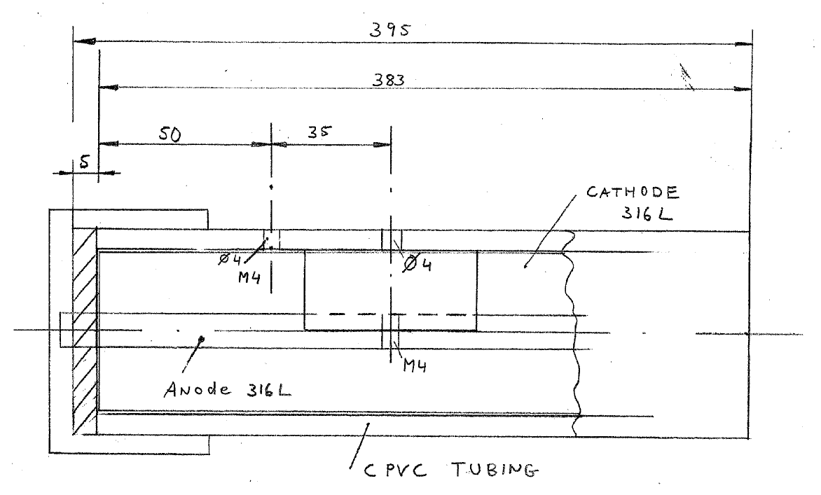

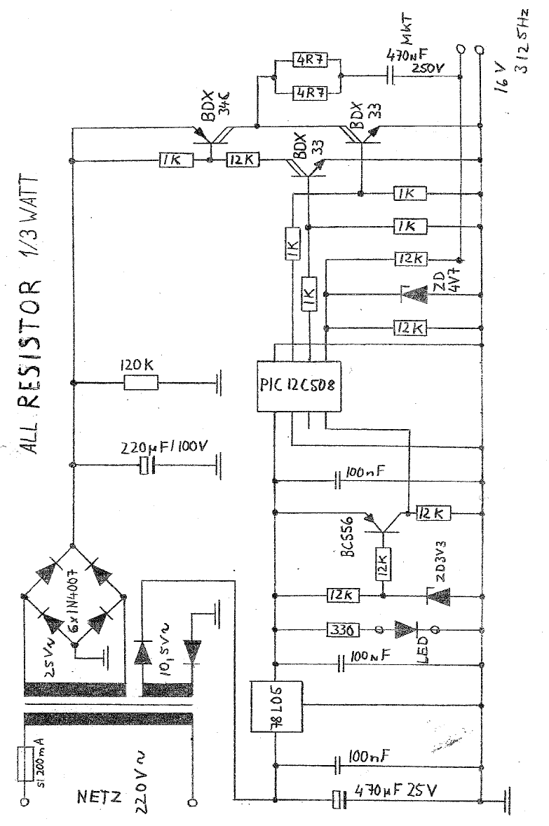

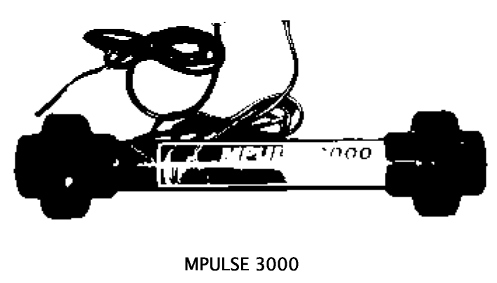

Scale protection system for swimming pool, spa and fountain surfaces.

The system functions by controlling the form changes of the calcium crystals.

What is claimed is:

1. The Mpulse 3000 System (Fig C) functions with an Electronic Module (Fig A) and a Reaction Chamber (Fig B). The Electronic Module (fig A) transfers 220VAC in to a lower Voltage (25V DC). The 25 VDC is changed to 16 Volts and is sent 3125 times per second, with 70 mA, through a cable to the Reaction Chamber (Fig B). The amount and form of the frequency is controlled by a microchip. Each impulse is formulated as 16 Volt positive/32 microsecond break/16 Volt negative/32 microsecond break. The 16 Volt, 70 mA and the frequency between 3125 and 4250, depending on the conductivity of the water, is the key for the changing of Calcium crystals in the Reaction Chamber (Fig B).
Inside the Reaction Chamber (Fig B) is a stainless steel Anode and Cathode (see Fig B). The material of the Anode and Cathode is 316L (chlorine resistant up to 1000 mg/l). If a non-controlled AC Voltage runs through stainless steel in water, corrosion will occur on the Anode and Cathode (see Fig B). With of the usage of short breaks (32 microsecond) between the positive Voltage and the negative Voltage on every impulse, corrosion will not occur. With the stabilization of the Anode and Cathode (see Fig B) a strong, changing electric field can be formed by giving a positive and negative Voltage, 3125 times per second to the Water. This energy is used to control the form of the growth of Calcium Crystals.
